(19) United States
(12) Patent Application Publication
(10) Pub. No.: US 2010/0104389 A1
(43) Pub. Date: Apr. 29, 2010

(54) TABLE APPARATUS OF MACHINE TOOL

(75) Inventor: Masataka Nakada, Ritto-shi (JP)

Correspondence Address: BIRCH STEWART KOLASCH & BIRCH, PO BOX 747, FALLS CHURCH, VA, 22040-0747, US

(73) Assignee: MITSUBISHI HEAVY INDUSTRIES, LTD., Tokyo (JP)

(21) Appl. No.: 12/528,833

(22) PCT Filed: Dec. 13, 2007
(86) PCT No.: PCT/JP2007/074012

§ 371 Date: Sep. 23, 2009

(30) Foreign Application Priority Data
Feb. 28, 2007 (JP) 2007-048299

(51) Int. Cl. B23C 1/14; B23Q 1/01

(52) U.S. Cl. 409/167

(57) ABSTRACT

A table apparatus 10 of a machine tool, which is arranged on a bed 30 and moves in a forward and rearward direction of the bed 30 by ball screws 51 and 52, includes: a table main body 11 onto which a workpiece is fixed; and supporting units 12 and 13 configured to be attached to the ball screws 51 and 52, respectively, to be detachably connected to table main body 11, and to be movable in an axis direction of the ball screws 51 and 52 along with rotation of the ball screws 51 and 52, respectively. The table apparatus 10 is configured so as to allow the connection of the table main body 11 and the supporting units 12 and 13 to be releasable in a state where at least one of the ball screws 51 and 52 is attached to the supporting unit 12 or 13.

### TECHNICAL FIELD

The present invention relates to a table apparatus of a machine tool.

### BACKGROUND ART

There is known a machine tool provided, on a bed constituting a main body of the tool, with: a headstock having a main spindle for rotating a workpiece, a tool or the like; a table onto which the workpiece is fixed, and which moves on a bed along a guide rail arranged and extending in the axis direction of the main spindle; and the like.

It has heretofore been considered for such machine tools: to configure a guide rail provided on a bed to be detachable so as to be capable of supporting a modular structure with multiple specifications (refer to Patent Document 1, for example); to build machine tools of different types using the same base unit, by replacing headstocks or the like to be provided on the base unit in accordance with applications, without replacing a main body (base unit) of the tool, such as a bed (refer to Patent Documents 2 and 3, for example); and the like.

### [Patent Document 1] Japanese Patent Application Publication No. 2002-126957

### [Patent Document 2] Japanese Patent Application Publication No. 2004-299040

[Patent Document 3] Japanese Patent Application Publication No. 2005-219167

### DISCLOSURE OF THE INVENTION

### [Problems to be Solved by the Invention]

However, a table configured to move on a bed by a ball screw in such an aforementioned machine tool conventionally has a structure in which a table main body having a workpiece fixed thereonto and a ball screw attachment portion having the ball screw attached thereto are formed into a single body. For this reason, in cases, for example, where the table is desired to be changed to one of a different type, where a trouble occurs on the ball screw, or the like, a troublesome work for removing the ball screw from the table needs to be performed regardless of the purpose. This requires a long time work, and therefore might cause a reduction in work efficiency.

In this respect, an object of the present invention is to provide a table apparatus of a machine tool, the table apparatus enabling a replacement work in accordance with a purpose and being capable of improving the work efficiency by shortening a time required for the work.

### [Means for Solving the Problems]

A table apparatus of a machine tool according to a first invention for solving the aforementioned problems is a table apparatus of the machine tool, the table apparatus being arranged on a bed which constitutes a machine body of the machine tool, and moving on the bed in a forward and rearward direction by ball screws, the table apparatus characterized by comprising: a table main body onto which a workpiece is fixed; and supporting units respectively attached to the ball screws, and detachably connected to the table main body, the supporting units being configured to be movable in an axis direction of the ball screws along with rotation of the ball screws, characterized in that the connection of the table main body and the supporting units is releasable in a state where at least one of the ball screws is attached to a corresponding one of the supporting units.

A table apparatus of a machine tool according to a second invention for solving the aforementioned problems is the table apparatus according to the first invention, characterized in that, the two supporting units are respectively arranged at positions on the opposite sides of the table main body from each other, and the table main body is configured to be detachable from the supporting units in a state where the positions of the supporting units are fixed.

A table apparatus of a machine tool according to a third invention for solving the aforementioned problems is the table apparatus according to the first invention, characterized in that, the table main body is attached to one of the ball screws, and is slidably supported by two guide rails each arranged on the bed and extending in the axis direction of the ball screws.

### EFFECTS OF THE INVENTION

In a case of the table apparatus of the machine tool according to the first invention, the table apparatus of the machine tool is configured of : a table main body onto which a workpiece is fixed; and supporting units configured to be attached to ball screws, respectively, so as to be detachably connected to the table main body, and to move the table main body in an axis direction of the ball screws along with rotation of the ball screws. In this table apparatus, the connection of the table main body and the supporting units is releasable in a state where the table main body or the supporting units are fixed. Thus, in accordance with a situation where the type of the table is desirably changed, a trouble occurs on the ball screw, or the like, only a necessary portion can be removed, and then replaced with another. Accordingly, the work to remove the ball screws from the table becomes no longer necessary, or is minimized. Thus, the work time can be shortened, and the work efficiency can be improved.

Moreover, in a case of the table apparatus of the machine tool according to the second invention, the two supporting units are respectively arranged at positions on the opposite sides of the table main body from each other, and the table main body is configured to be detachable with respect to the supporting units in a state where the positions of the supporting units are fixed. Thus, in addition to the effects brought by the first table apparatus of the machine tool, in a case where the type of the table is desirably changed, only the table main body can be replaced with another while the state where the supporting units are attached to the ball screws is maintained. Thus, the work to remove the ball screws is no longer necessary, so that, the time involved with the replacement work can be shortened.

In addition, in a case of the table apparatus of the machine tool according to the third invention, the table main body is attached to one of the ball screws, and is slidably supported by the two guide rails each arranged on the bed and extending in the axis direction of the ball screw. Thus, the table main body alone becomes movable on the bed, and a single shaft operation or double shaft operation can be selected in accordance with a purpose. Thereby, the usability thereof improves.

### BRIEF DESCRIPTION OF THE DRAWINGS

FIG. 1 is a schematic view showing an inner structure of a machine tool.

FIG. 2 is a perspective view showing an external appearance of a table according to Embodiment 1 of the present invention.

FIG. 3 is a perspective view showing an external appearance of the table according to Embodiment 1 of the present invention.

FIG. 4 is a schematic view of the table according to Embodiment 1 of the present invention.

FIG. 5 is an enlarged view showing a part of the table according to Embodiment 1 of the present invention in an enlarged manner.

FIG. 6 is a front view showing another example of the table according to Embodiment 1 of the present invention.

FIG. 7 is a front view showing a table according to Embodiment 2 of the present invention.

### BEST MODES FOR CARRYING OUT THE INVENTION

The present invention will be described in details in the following embodiments.

### EMBODIMENT 1

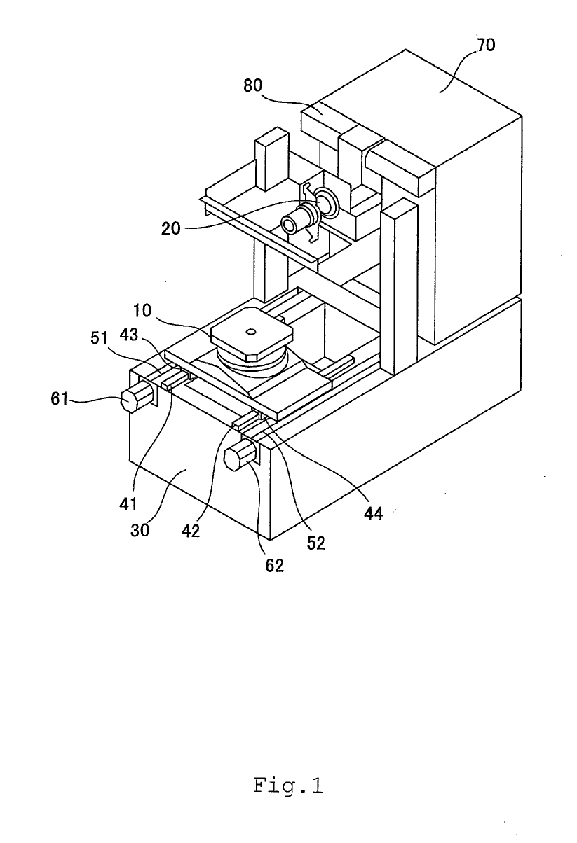

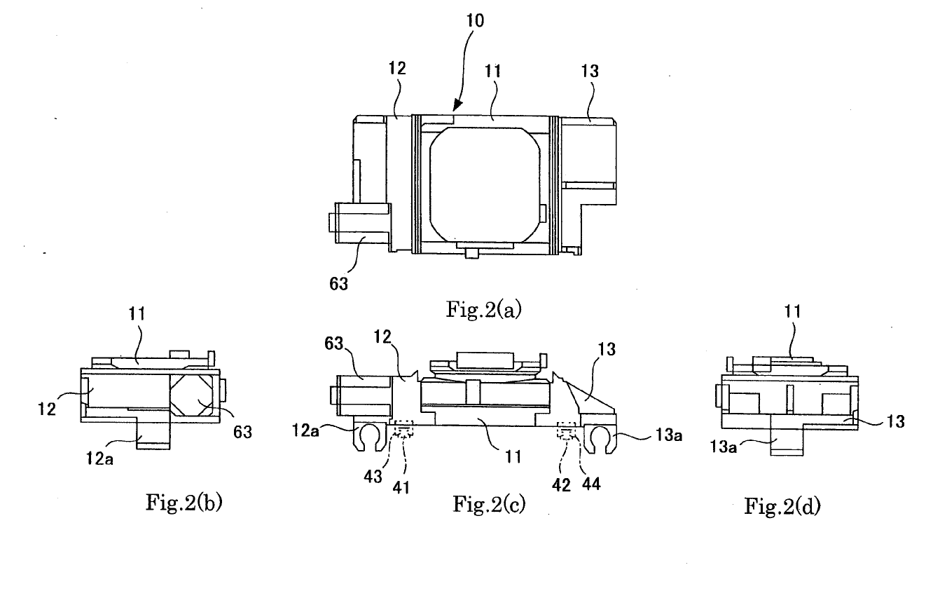

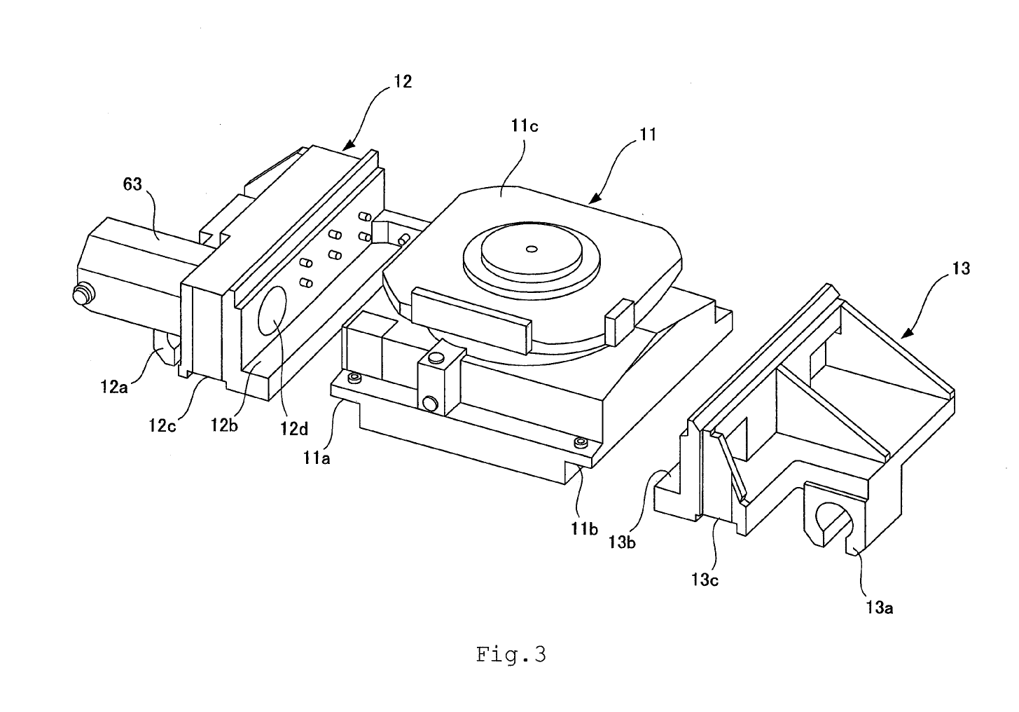

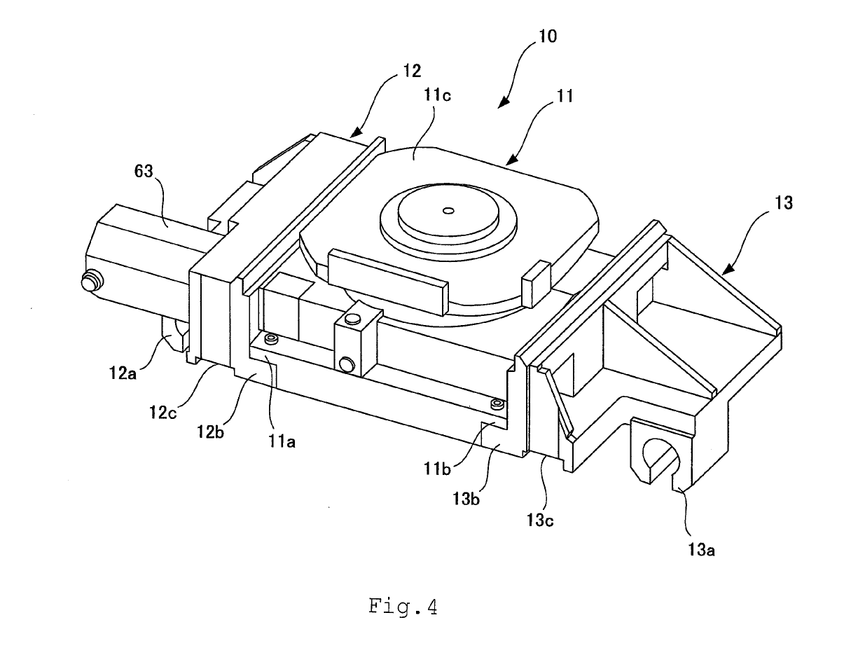

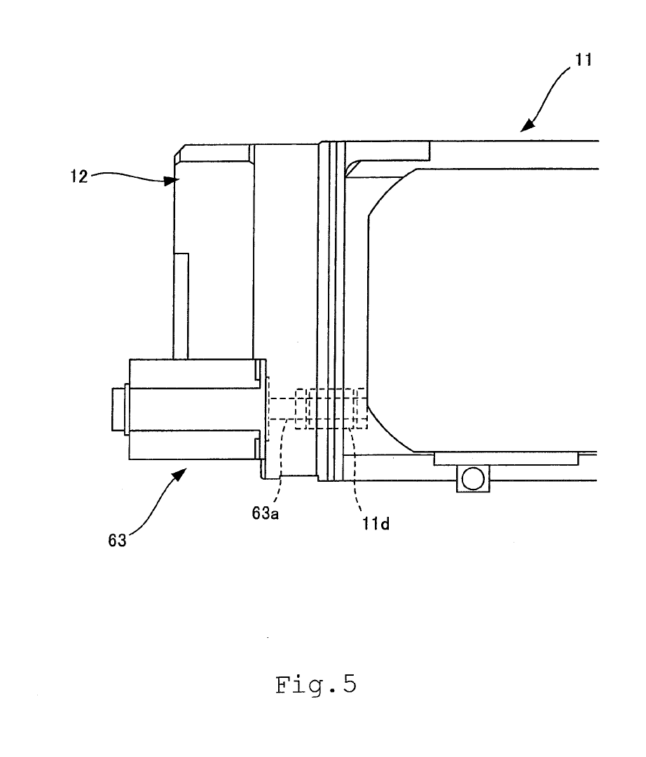

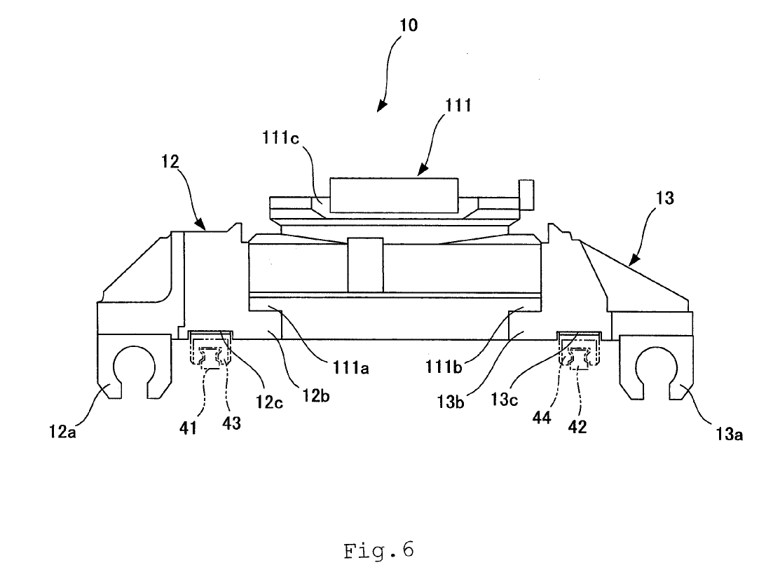

Embodiment 1 of the present invention will be described in details on the basis of FIGS. 1 to 6. FIG. 1 is a schematic view of a machine tool. Part (a) of FIG. 2 is a top view of a table apparatus including a rotation table having a rotary shaft according to this embodiment. Parts (a) and (b) of FIGS. 2b and 2d are side views of Part (a) of FIG. 2. Part (c) of FIG. 2 is a front view of Part (a) of FIG. 2. FIGS. 3 and 4 are perspective views each showing an external appearance of the table apparatus shown in FIG. 2. FIG. 5 is an explanatory diagram showing a connection part of the table apparatus shown in FIG. 2 in a partially enlarged manner. FIG. 6 is a front view showing an example of a table apparatus including a fixed table not having the rotary shaft of this embodiment.

As shown in FIG. 1, in this embodiment, a table apparatus 10 is arranged on a bed 30 that constitutes a machine body of a machine tool together with a headstock 20 and the like attached to a main spindle so as to provide rotation to a workpiece or tool. Hereinafter, a description will be given while a left side in FIG. 1 is referred to as a forward direction, and a left side in FIG. 1 is referred to as a rearward direction.

Guide rails 41 and 42 as well as ball screws 51 and 52 extend on the bed 30 in the forward and rearward direction of the bed 30 and along the axis direction of the main spindle. Then, guide blocks 43 and 44 configured to be slidable along the guide rails 41 and 42 are supported on the guide rails 41 and 42, respectively. In addition, the ball screws 51 and 52 are arranged in parallel with each other at outer sides of the guide rails 41 and 42, so as to sandwich the guide rails 41 and 42 therebetween. Motors 61 and 62 are connected to shaft ends of the ball screws 51 and 52, respectively.

The table apparatus 10 is fixed onto the guide blocks 43 and 44 and is also attached to the ball screws 51 and 52. The table apparatus 10 is configured to move in the forward and rearward direction on the bed 30 by rotation of the shafts of the ball screws 51 and 52 involved with driving of the motors 61 and 62. Note that, the headstock 20 is provided to a column 70 installed at a rear portion of the bed 30, with a saddle 80 interposed therebetween.

Next, a description will be given of a structure of the table apparatus 10 of this embodiment in detail on the basis of FIGS. 2 to 6. As shown in FIGS. 2 to 6, in this embodiment, the table apparatus 10 is configured of a table main body 11 and supporting units 12 and 13 . The table main body 11 includes a rotation table 11c onto which a workpiece being material to be machined is fixed, and which provides rotation about an axis in a vertical direction to the workpiece by driving of a motor 63. The supporting units 12 and 13 are configured to be attachable to the ball screws 51 and 52, respectively, and are arranged so as to face each other with the table main body 11 interposed therebetween. The supporting units 12 and 13 are detachably connected to left and right sides of the table main body 11, respectively. The motor 63 is connected to the supporting unit 12.

The table main body 11 is provided, at a pair of left and right side surfaces opposing to each other, with supporting unit connection parts lla and llb to be connected to the supporting units 12 and 13, respectively. The table main body 11 is also provided with the rotation table 11c, which provides rotation about an axis in a vertical direction to the workpiece by the driving of the motor 63. The top portions of surfaces of the connection parts 11a and 11b, which face the supporting units 12 and 13, respectively, are formed in a shape protruding toward the supporting units 12 and 13 with respect to the bottom portions thereof, respectively. In other words, the bottom portions of the surfaces of the connection parts 11a and 11b, which face the supporting units 12 and 13, respectively, are formed in a shape dented inwardly from the bottom edges thereof by a predetermined height, respectively.

In addition, the supporting unit 12 is provided with: a ball screw attachment part 12a configured so that the ball screw 51 positioned at a left side on the bed 30 can be attached thereto; a main body connection part 12b configured to be attachable to the supporting unit connection part 11a; and a guide block attachment part 12c configured to be fixable onto the guide block 43. Moreover, formed is a through hole 12d configured so that the rotary shaft of the motor 63 can be inserted therethroguh.

The ball screw attachment part 12a is provided at a bottom surface of the supporting unit 12. The ball screw 51 arranged at the left side on the bed 30 is attached to the ball screw attachment part 12a. Furthermore, the main body connection part 12b is provided at a surface of the supporting unit 12, which faces the table main body 11. The shape of the main body connection part 12b is formed in a shape that fits with the supporting unit connection part 11a, that is, a shape in which the bottom portion of the surface facing the table main body 11 protrudes toward the table main body 11 along the bottom edge thereof by a predetermined height.

The guide block 43 supported by the guide rail 41 arranged in parallel with the ball screw 51 is fixed to the guide block attachment part 12c. Thereby, the supporting unit 12, which moves by the ball screw 51, can smoothly slide on the bed 30.

Furthermore, the through hole 12d has an opening at a surface facing the table main body 11, and is configured so that a rotary shaft 63a of the motor 63 can be inserted therethrough. Note that, the motor 63 is configured to be connected, via the through hole 12d, to a transmission mechanism (illustration thereof is omitted) provided at the table main body 11, and to rotate the rotation table 11c by the driving of the motor 63.

In addition, the supporting unit 13 is provided with: a ball screw attachment part 13a to which the ball screw 52 positioned at a right side on the bed 30 is attached; a main body connection unit 13b connected to the supporting unit connection part lib provided at the main table body 11; and also, a guide block attachment unit 13c to which the guide block 44 is fixed.

The ball screw attachment part 13a is provided at a bottom surface of the supporting unit 13 . The ball screw 52 arranged at the right side on the bed 30 is attached to the ball screw attachment part 13a. Furthermore, the main body connection part 13b is provided at a surface of the supporting unit 13, which faces the table main body 11. The shape of the main body connection part 13b is formed in a shape that fits with the supporting unit connection part 11b, that is, a shape in which the bottom portion of the surface facing the table main body 11 protrudes toward the table main body 11 along the bottom edge thereof by a predetermined height.

Moreover, the guide block 44 supported by the guide rail 42 extending in parallel with the ball screw 52 is fixed to the guide block attachment part 13c. The supporting unit 13, which moves by the rotation of the ball screw 52, is thereby configured to smoothly slide on the bed 30.

The table apparatus 10 of this embodiment is used in a state in which the table main body 11 and the supporting units 12 and 13 are integrated into a single body, that is, in a state in which the supporting unit connection parts 11a and 11b and the main body connection parts 12b and 13b are fastened by bolts and are mutually connected, respectively.

Thereby, the table main body 11 connected to the supporting units 12 and 13 moves a workpiece in the forward and rearward direction of the bed 30, together with the supporting units 12 and 13, which move when the shafts of the ball screws 51 and 52 are rotated by the driving of the motors 61 and 62, respectively.

Note that, as shown in FIG. 5, the motor 63 is connected, via the through hole 12d and a rotary shaft connection part lid provided at the table main body 11, to the transmission mechanism provided at the table main body 11. This configuration enables connection between the motor 63 and the transmission mechanism after the table main body 11 is fixed to the supporting unit 12, by a work for connecting the motor 63 such as providing a window (illustration is omitted) at the table main body 11, and thereby connecting, via the window, the rotary shaft 63a of the motor 63, which is to be inserted from the through hole 12d, to the transmission mechanism provided at the table main body 11.

FIG. 6 shows an example using, instead of the table main body 11 shown in FIGS. 2 to 5, a table main body ill provided with a fixed table 111c not having a rotary shaft in a vertical direction. The supporting units 12 and 13 in FIG. 6 are the same as those shown in FIGS. 2 to 5.

Supporting unit connection parts 111a and 111b connected respectively to the supporting units 12 and 13 are provided respectively at a pair of opposite side surfaces of the table main body 111. The top portions of surfaces of the connection parts 111a and 111b, which face the supporting units 12 and 13, respectively, are formed in a shape protruding toward the supporting units 12 and 13 with respect to the bottom portions thereof, respectively. In other words, the connection parts 111a and 111b include a shape obtained by moving, inwardly from the bottom edges thereof by a predetermined height, respectively, the bottom portions of the surfaces facing the respective supporting units 12 and 13.

Specifically, as compared with the table main body 11 shown in FIGS. 2 to 5, the table main body 111 shown in FIG. 6 is different in that the table main body 111 includes the fixed table 111c instead of the rotation table 11c and does not include a transmission mechanism, and has substantially the same configuration of the other parts as the table main body 11.

In this embodiment, when the table main body 11 provided with the rotation table 11c connected to the supporting units 12 and 13 is replaced with the table main body 111 including the fixed table 111c, the table main body 11 and the supporting units 12 and 13 are separated by moving the table main body 11 in an upward or forward direction after the motor 63 and the bolts are removed therefrom. Then, the supporting unit connection parts 111a and 111b are fitted with the main body connection parts 12b and 13b, respectively, and then, the table main body 111 is connected to the supporting units 12 and 13 by fastening the table main body 111 and the supporting units 12 and 13 with the bolts, respectively.

As described above, in the machine tool according to this embodiment, for example, the table main body 11 including the rotation table 11c can be replaced with the table main body 111 including the fixed table 111c, while the state in which the supporting units 12 and 13 are attached to the ball screws and the guide blocks 43 and 44, respectively, for example, is maintained. In a case where the type of the table apparatus 10 is changed to another, only the table main body can be replaced with another, instead of the entire table apparatus 10. Thus, a troublesome work conventionally required in changing the type of a table to another is no longer necessary. Accordingly, shortening of the work time, and the work efficiency can be improved.

In addition, also in a case, for example, where a trouble occurs on the ball screws 51 and 52, the rotation table 11c, or the like, it is unnecessary to replace the entire table apparatus 10, and only any of the table main body 11 and the supporting units 12 and 13 can be replaced with another according to the purpose. Thus, the time involved with the replacing work can be shortened, and thereby, the work efficiency can be improved.

Note that, FIG. 2 shows the table apparatus 10 in a state in which the gap between the supporting units 12 and 13 is wider than the width of the table main body 11 for the purpose of describing the structure of the table apparatus 10. However, in a case where the table main body 11 is actually attached or detached, the table main body 11 is moved from an upward or forward direction or is moved in an upward or forward direction in a state in which the supporting units 12 and 13 are attached to the ball screws 51 and 52 and the guide blocks 43 and 44, respectively, and the distance between the supporting units 12 and 13 is approximately equal to the width of the table main body 11.

In addition, it is preferable to form a desired gap between the surfaces of the table main body 11 and the supporting unit 13, which face with each other, so that the table main body 11 can be even more smoothly attached or detached.

### EMBODIMENT 2

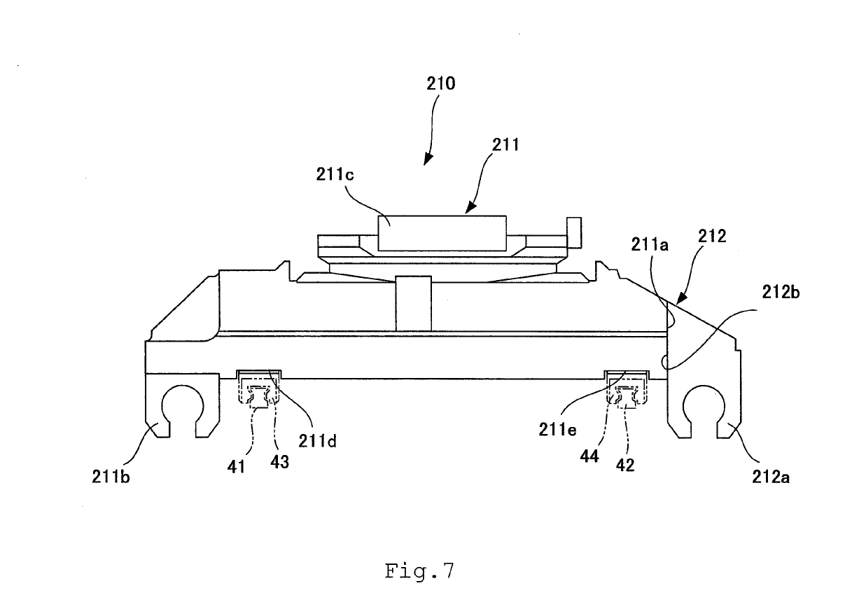

A detailed description will be given of Embodiment 2 of the present invention on the basis of FIG. 7. FIG. 7 is a front view showing a table according to this embodiment of the present invention. This embodiment is an embodiment to which a table 210 configured to include one supporting unit 212 detachably connected to one side of a table main body 211 is applied, instead of the table apparatus 10 configured to include the two supporting units 12 and 13 detachably attached to the both sides of the table main body 11, respectively, in the machine tool shown in FIG. 1. Note that, duplicative descriptions of the aforementioned components shown in FIG. 1 are omitted.

As shown in FIG. 7, the table apparatus 210 is constituted of: the table main body 211 which is provided with a rotation table 211c for rotating, by a motor (illustration is omitted), machining-target material to be subjected to machining by the machine tool, about an axis in a vertical direction, and which is to be attached to the ball screw 51; and a supporting unit 212 detachably connected to the table main body 211.

The table main body 211 is provided with: a supporting unit connection part 211a, which is the portion connected to the supporting unit 212; a ball screw attachment part 212b to which the ball screw 51 is attached; and guide block attachment parts 211d and 211e to which the guide blocks 43 and 44 are fixed, respectively. The guide blocks 43 and 44 are fixed to the guide block attachment parts 211d and 211e, respectively, and thereby, the table main body 211, which moves along with the rotation of the ball screw 51, is configured to be slidable on the bed 30.

In addition, the supporting unit 212 is provided with a ball screw attachment part 212a to which the ball screw 52 is attached, and a main body connection part 211b, which is a portion connected to the table main body 211. The ball screw attachment part 212a is provided at a bottom surface of the supporting unit 212, and the ball screw 52 provided on the bed 30 is attached to the ball screw attachment part 212a. The supporting unit 212 is configured to move in the forward and rearward direction of the bed 30 along with the rotation of the ball screw 52.

In this embodiment, the supporting unit 212 is configured to move on the bed 30 only in a state where the supporting unit 212 is connected to the table main body 211. In other words, the table main body 211 is capable of moving on the bed 30 in the forward and rearward direction even in a state where the table main body 211 is not connected to the supporting unit 212.

With the table apparatus of the machine tool according to the aforementioned embodiment, in a case where a trouble occurs on the ball screw 51 or 52, or the table main body 211 provided with the rotation table 211c is replaced with a table main body (illustration is omitted) provided with a fixed table, only any of the table main body 211 and the supporting unit 212 can be replaced to another. Accordingly, it is unnecessary to remove the two ball screws 51 and 52 at the same time. Thus, the time involved with the replacing work can be shortened, and the work efficiency can be improved.

Moreover, it is possible to release the connection of the table main body 211 and the supporting unit 212 when necessary, and to move the table main body 211 by the one ball screw 51, that is, to enable a so called single shaft operation. Alternatively, it is also possible to connect the supporting unit 212 and the table main body 211, and then to move the table apparatus 210 by use of the two ball screws 51 and 52, that is, to enable a so-called double shaft operation. Thus, since selection of the single shaft operation or the double shaft operation is enabled, usability can be improved.

Note that, the motor provided as the drive source of the rotation table 211c is to be connected to the table main body 211. Thereby, the table main body 211 can support the aforementioned single shaft operation. Moreover, although details are omitted in FIG. 7, the table main body 211 and the supporting unit 212 are to be connected by fastening with bolts or the like, and the supporting unit connection part 211a and the main body connection part 212b may be configured so as to allow the connection state to be released even when any one of the table main body 211 and the supporting unit 212 is attached to a corresponding one of the ball screws 51 and 52.

### INDUSTRIAL APPLICABILITY

The present invention is applicable to a table apparatus of a machine tool.

1. A table apparatus of a machine tool, the table apparatus being arranged on a bed which constitutes a machine body of the machine tool and moving on the bed in a forward and rearward direction by ball screws, the table apparatus characterized by comprising:
a table main body onto which a workppiece is fixed; and
supporting units respectively attached to the ball screws and detachably connected to the table main body, the supporting units being configured to be movable in an axis direction of the ball screws along with rotation of the ball screws, characterized in that
the connection of the table main body and the supporting units is releasable in a state where at least one of the ball screws is attached to a corresponding one of the supporting units.

2. The table apparatus of the machine tool according to claim 1, characterized in that,
the two supporting units are respectively arranged at positions on the opposite sides of the table main body from each other, and
the table main body is configured to be detachable from the supporting units in a state where the positions of the supporting units are fixed.

3. The table apparatus of the machine tool according to claim 1, characterized in that, the table main body is attached to one of the ball screws, and is slidably supported by two guide rails each arranged on the bed and extending in the axis direction of the ball screws.
